(19) United States
(12) Patent Application Publication
(10) Pub. No.: US 2023/0407138 A1
(43) Pub. Date: Dec. 21, 2023

(54) AN ISOLATOR FOR PROTECTING DISSIMILAR SUBSTRATES FROM GALVANIC CORROSION

(71) Applicant: 3M INNOVATIVE PROPERTIES COMPANY, St. Paul, MN (US)

(72) Inventors: Dmitriy SALNIKOV, Woodbury, MN (US); Matthew J. SCHMID, Roberts, WI (US); Justin M. BOLTON, Minneapolis, MN (US)

(21) Appl. No.: 18/251,021

(22) PCT Filed: Sep. 30, 2021
(86) PCT No.: PCT/IB2021/059006

§ 371 Date: Apr. 28, 2023

Related U.S. Application Data
(60) Provisional application No. 63/108,825, filed on Nov. 2, 2020.

(51) Int. Cl. C09J 7/24

(52) U.S. Cl. CPC C09J 7/243; C09J 7/245; C09J 2301/312

(57) ABSTRACT

An isolator for protecting adjacently located dissimilar material substrates from galvanic corrosion. The isolator includes a backing layer having opposite major surfaces and a thickness, and an optional uncured adhesive layer having one major surface bonded to one of the major surfaces of the backing layer and another major exposed surface for being adhesively bondable to a surface of one of the dissimilar material substrates. In its cured state, the adhesive layer and the backing layer are each not permanently compressible. At least one or both of the cured adhesive layer and the backing layer is polar solvent resistant enough to prevent polar solvent transported metal ions from passing all the way through its thickness. In preferred embodiments the backing layer comprises a tetrafluoroethylene, hexafluoropropylene and vinylidene fluoride (THV) material, and the adhesive layer comprises an epoxy resin.

The present invention relates to the isolation of dissimilar substrates that would otherwise be prone to galvanic corrosion, in particular to such isolation of dissimilar metal substrates, and more particularly, to the isolation of dissimilar metal substrates that are mechanically fastened together.

### BACKGROUND

There is a trend in the transportation industry (e.g., automobiles and aircraft) for reducing weight (i.e., light-weighting) by using lower density materials in place of higher density materials. In the automobile industry, for example, lighter aluminum and fiber reinforced plastic composite materials have been used in place of heavier steel materials for some structural and body components of the automobiles (e.g., an aluminum material truck bed with a steel body frame). With the use of such dissimilar materials, the risk of galvanic corrosion increases. Various approaches have been tried to address this problem. One such approach, for example, can be found in U.S. Pat. No. 9,604,676. The present invention is an improvement over such approaches.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY OF THE INVENTION

The present invention provides an isolation barrier or isolator (e.g., in the form of an isolation layer) that is designed to isolate dissimilar material (e.g., dissimilar metal) substrates from each other, where one or both of those substrates would otherwise be prone to galvanic corrosion, if they were not isolated from each other (i.e., prevented from contacting each other, or otherwise prevented from having ions pass from one substrate toward the other).

In one aspect of the present invention, an isolator is provided for protecting adjacently located dissimilar material substrates from galvanic corrosion. The isolator includes an isolation or backing layer having opposite major surfaces and a thickness, and optionally an uncured adhesive layer having one major surface bonded to one of the major surfaces of the backing layer and another major exposed surface for being adhesively bondable to a surface of one of the dissimilar material substrates. The backing layer is not permanently compressible, in accordance with the principles of the present invention, and in its cured state, the adhesive layer is also not permanently compressible. At least one of the cured adhesive layer and the backing layer is, and preferably both are, resistant enough to polar solvents (e.g., water) and mixtures thereof so as to prevent the transfer of electrolytes (e.g., water transported metal ions) from passing all the way through its thickness. Optionally, at least one of the cured adhesive layer and the backing layer is, and preferably both are, electrically insulative, when measured according to ASTM D57-99.

Because it either does not include an adhesive layer or includes a backing layer and an adhesive layer (i.e., the adhesive layer alone is not used as the isolator), the present isolator can be utilized (a) using less energy, because there is no or less adhesive to cure, and (b) without the risk of bonding the dissimilar material substrates together, because when used, an adhesive layer is bonded to only one side of the backing layer. Other potential benefits of the present isolator include, but are not limited to, (c) increasing resistance to shear stress and strain between the dissimilar material substrates, and (d) reduce noise and/or dampen vibrations passing through from one substrate to the other.

In another aspect of the present invention, an isolated substrate joint is provided that comprises two dissimilar material substrates, at least one isolator disposed between the two dissimilar material substrates, and a mechanical fastener connecting together the dissimilar material substrates, with the at least one isolator remaining fixed in relation to its location between the dissimilar material substrates so as not to allow movement of either dissimilar material substrate, relative to the isolator, that causes wearing away of the isolator in its thickness direction.

In another aspect of the present invention, a method is provided for protecting mechanically fastened dissimilar material substrates from galvanic corrosion. The method comprises providing a first substrate comprising a first material and a second substrate comprising a second material, where the first material and the second material are dissimilar materials (e.g., steel and aluminum); providing an isolator; adhesively bonding the isolator to a surface of the first material substrate; and mechanically securing together the first and second material substrates such that the isolator is disposed therebetween in an elastically compressed state.

These and other aspects, features and/or advantages of the invention are further shown and described in the drawings and detailed description herein, where like reference numerals are used to represent similar parts. It is to be understood, however, that the drawings and description are for illustration purposes only and should not be read in a manner that would unduly limit the scope of this invention.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

In the accompanying drawings:

FIG. 1 is a side view of a conventional mechanically fastened joint of two dissimilar metal substrates, with evidence of galvanic corrosion at the interface between the substrates, along with an enlarged view of that corroded interface;

FIG. 2 is a side view of a mechanically fastened joint, like that of FIG. 1, but with an embodiment of an isolator in accordance with the present invention disposed between the two dissimilar metal substrates, along with an enlarged view of the interface and the isolator being shown in cross-section;

FIG. 3 is a side view of the joint of FIG. 2, with one of the substrates backed-off so as to illustrate the serviceability of the joint;

FIG. 4 is a top photographic view of an isolator, according to one embodiment of the present invention, having been formed into a three-dimensional shape;

FIG. 5 is a cross-sectioned side view of an isolator, similar to that of FIG. 4, disposed between the walls of two dissimilar metal substrates, with the isolator being adhesively bonded to the surface of the wall of one of the dissimilar metal substrates;

FIGS. 6A and 6B are perspective view photos of a 1.0 inch diameter cylinder and a 0.5 inch diameter cylinder, respectively, used for the Bending Radius Test, with different size structural adhesive backed isolator samples adhered to each cylinder;

FIGS. 7A and 7B are side view photos of the cylinders and isolator samples of FIGS. 6A and 6B, while positioned in an adhesive curing oven; and

FIGS. 8A and 8B are side view photos of the cylinders and isolator samples of FIGS. 6A and 6B, removed from the adhesive curing oven, after the adhesive layers are cured.

### DETAILED DESCRIPTION OF CERTAIN EMBODIMENTS

In describing preferred embodiments of the invention, specific terminology is used for the sake of clarity. The invention, however, is not intended to be limited to the specific terms so selected, and each term so selected includes all technical equivalents that operate similarly.

The recitation of numerical ranges by endpoints includes all numbers subsumed within that range in increments commensurate with the degree of accuracy indicated by the end points of the specified range (e.g., for a range of from 1.000 to 5.000, the increments will be 0.001, and the range will include 1.000, 1.001, 1.002, etc., 1.100, 1.101, 1.102, etc., 2.000, 2.001, 2.002, etc., 2.100, 2.101, 2.102, etc., 3.000, 3.001, 3.002, etc., 3.100, 3.101, 3.102, etc., 4.000, 4.001, 4.002, etc., 4.100, 4.101, 4.102, etc., 5.000, 5.001, 5.002, etc. up to 5.999) and any range within that range, unless expressly indicated otherwise.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “polymer” will be understood to include polymers, copolymers (e.g., polymers formed using two or more different monomers), oligomers and combinations thereof, as well as polymers, oligomers, or copolymers that can be formed in a miscible blend.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a nanoparticle that comprises “a” fluorescent molecule-binding group can be interpreted to mean that the nanoparticle includes “one or more” fluorescent molecule-binding groups.

As used herein, “a,” “an,” “the,” “at least one,” and “one or more” are used interchangeably. Thus, for example, a nanoparticle that comprises “a” fluorescent molecule-binding group can be interpreted to mean that the nanoparticle includes “one or more” fluorescent molecule-binding groups.

The term “and/or” means one or all of the listed elements or a combination of any two or more of the listed elements (e.g., preventing and/or treating an affliction means preventing, treating, or both treating and preventing further afflictions).

As used herein, the term “or” is generally employed in its sense including “and/or” unless the content clearly dictates otherwise.

Also herein, the recitations of numerical ranges by endpoints include all numbers subsumed within that range (e.g., 1 to 5 includes 1, 1.5, 2, 2.75, 3, 3.80, 4, 5, etc.).

The present invention provides an isolation barrier or isolator (e.g., in the form of an isolation layer) that is designed to isolate dissimilar (e.g., dissimilar metal) substrates from each other, where one or both of those substrates would otherwise be prone to galvanic corrosion, if they were not isolated from each other (i.e., prevented from contacting each other, or otherwise prevented from having ions pass from one substrate toward the other). It is desirable for the isolator to remain fixed in relation to its location between the dissimilar substrates so as not to allow movement of either substrate relative to the isolator, and in particular, movement that causes wearing away of the isolator in its thickness direction. The isolator can be so fixed in place by being mechanically clamped under compressive forces or pressure between the dissimilar substrates, or by being adhesively bonded to one of the dissimilar substrates, or both. When an adhesive bond is used, it is preferable to form a structural adhesive bond between the isolator and one of the dissimilar substrates, such that the isolator and/or the adhesive fails before a bond failure occurs between the isolator and the adhesive or the adhesive and the substrate.

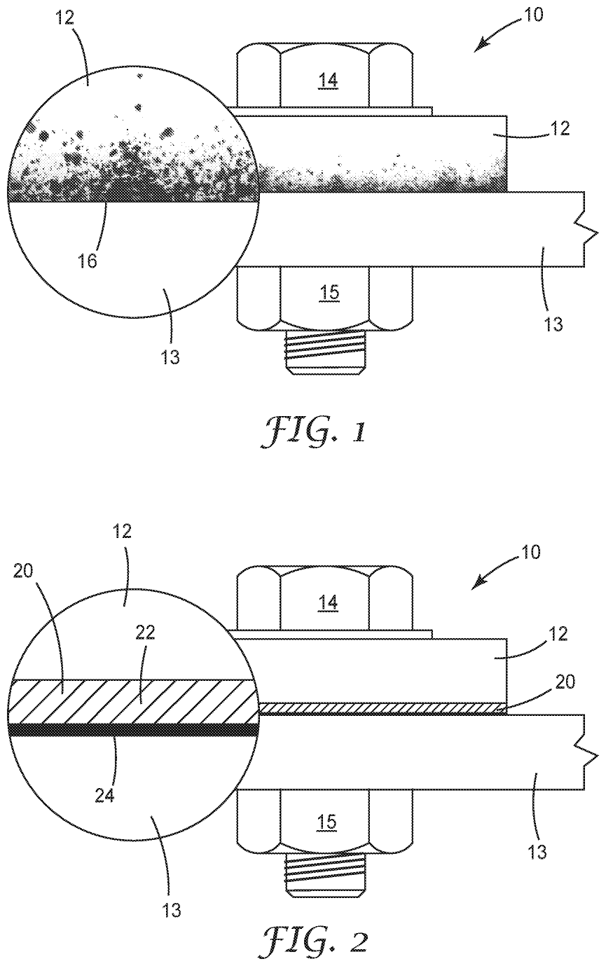

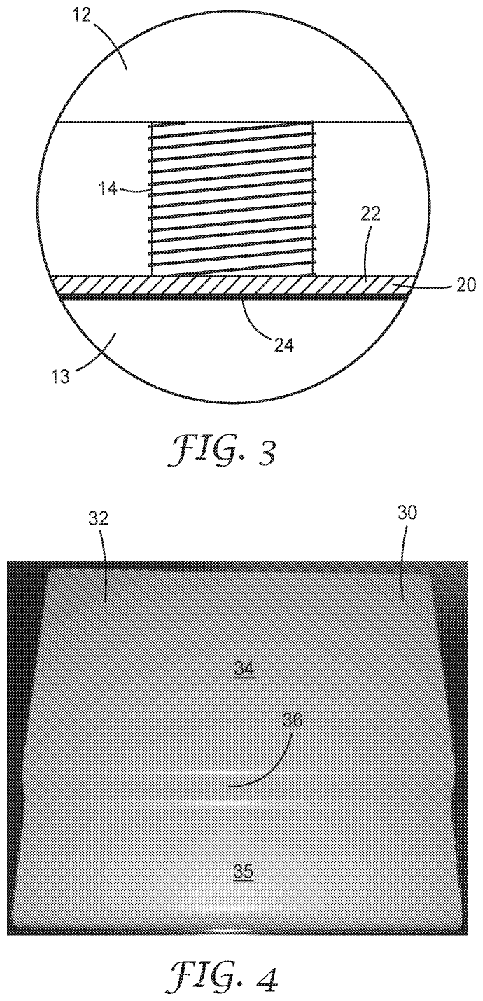

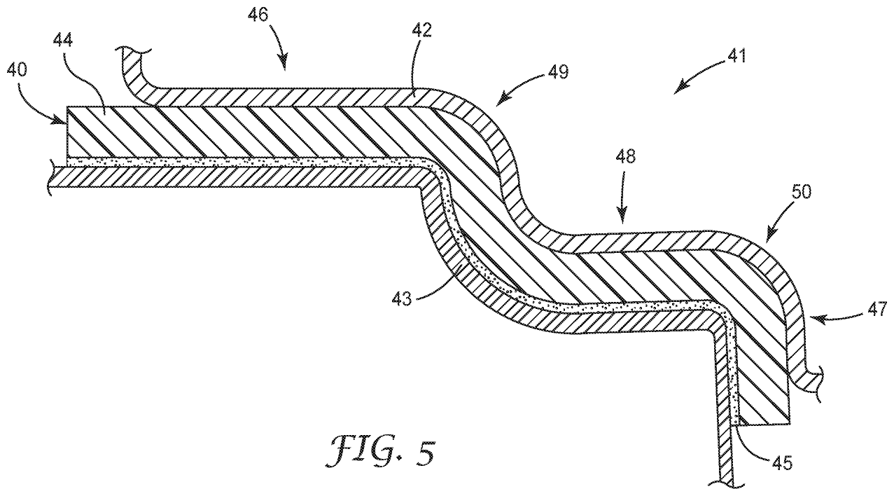

Referring to FIG. 1, a conventional mechanically fastened joint 10 of two dissimilar metal substrates 12 and 13 (e.g., made of a steel and aluminum metal, respectively) is fastened together with a bolt 14 and nut 15. Because the two dissimilar metal substrates 12 and 13 are in direct contact with each other, galvanic corrosion 16 is evidenced at the interface between the substrates 12 and 13 (see, e.g., the enlarged view of that corroded interface 16). In one embodiment of the present invention (see FIG. 2), an isolator 20 is disposed between the two dissimilar metal substrates 12 and 13 of the mechanically fastened joint 10. This embodiment of the isolator 20 includes an isolation or backing layer 22 having opposite major surfaces and a thickness therebetween, along with an adhesive layer 24 having a thickness defined by opposite major surfaces. One of the opposite major surfaces is bonded to one of the major surfaces of the backing layer 22 and the other major surface is a major exposed surface adhesively bonded to a surface of the dissimilar metal substrate 13. Depending on the configuration of the substrates 12 and 13 (see, e.g., FIG. 5) and/or the mechanical fastening system used, the adhesive layer 24 may be optional. Referring to FIG. 3, because the backing layer 22 is not bonded to the substrate 12, the nut 15 and bolt 14 can be loosened or removed and the substrates 12 and 13 separated to allow the joint 10 to be serviced.

Referring to FIG. 4, the invention includes an isolator 30 with an isolation or backing layer 32, and corresponding optional adhesive layer (not shown), that has been formed (e.g., as described below) into a desired three-dimensional shape having an upper flat section 34 and lower flat section 35 separated by a transition region 36 of two bends. Referring to FIG. 5, such an isolator 40 has a desired three-dimensional shape that matches the contours of a joint 41 made from a corresponding pair of dissimilar metal substrates 42 and 43. The isolator 40 includes an isolation or backing layer 44 and an adhesive layer 45 that are formed into the desired three-dimensional shape. The joint 41 (i.e., isolator 40 and substrates 42 and 43) includes multiple flat sections and transition bending regions. In particular, for example, the joint 41 includes a horizontal upper flat section 46, a vertical lower section 47 and another horizontal middle section 48 disposed therebetween. Between sections 46 and 48 is a bend 49, with a desired radius of curvature, and between sections 48 and 47 is another bend 50, with a desired radius of curvature.

The isolator 40 can be formed into the desired three-dimensional shape before being disposed between the substrates 42 and 43 (i.e., before the joint 41 is formed). Alternatively, the isolator 40 can be formed during the forming of the joint 41, for example, by deforming the backing layer 44 to conform to the contours of the substrates 42 and 43, while the adhesive layer is being adhered to the substrate 43. With this alternative procedure, it can be desirable for the substrates 42 and 43 to have matching contours (i.e., three-dimensional shapes). In another embodiment, the isolator 40 can be formed during the forming of the joint 41, for example, by deforming the backing layer 44 to conform to the contours of the substrates 42 and 43, without an adhesive layer 45 or while not bonding the adhesive layer 45 to the substrate 43. This can be accomplished by mechanically compressing and fastening the two substrates 42 and 43 together with the isolator 40 disposed therebetween and so as to deform the isolator 40 to match the shapes of the substrates 42 and 43. If the adhesive layer 45 is included, the joint can then be heated or otherwise processed to adhesively bond the layer 45 to the substrate 43. With this latter procedure, it is desirable for the substrates 42 and 43 to be sufficiently stiff and strong so as to maintain their desired shape during the deformation of the isolator 40 therebetween.

The following Examples have been selected merely to further illustrate features, advantages, and other details of the invention. It is to be expressly understood, however, that while the Examples serve this purpose, the particular ingredients and amounts used as well as other conditions and details are not to be construed in a manner that would unduly limit the scope of this invention.

TABLE 1
Materials

| Designation | Description | Source |
|---|---|---|
| SAT1010 | Single layer epoxy-based structural | 3M Company, |
| | adhesive tape available under the | St. Paul, MN, |
| | trade designation 3M SAT1010 | United States |
| THV 500 | Fluorothemoplastic containing | 3M Company |
| | tetrafluoroethylene, | |
| | hexafluoropropylene and vinylidene | |
| | fluoride (THV) available under the | |
| | trade designation 3M DYNEON | |
| | Fluoroplastic THV 500 | |
| HMDSO | Hexamethyldisiloxane | Gelest Inc, |
| | | Morrisville, |
| | | PA, United |
| | | States |
| O₂ | Oxygen (UHP compressed gas) | Oxygen Service |
| | | Company, |
| | | St. Paul, MN, |
| | | United States |

### Test Methods

### Torque Loss Test

A 4.76 mm ( 3/16 inch) 6061 aluminum sheet approximately 20.32 cm×30.48 cm (8 inch×12 inch) was drilled with 1.27 cm (0.5 inch) diameter holes such they were at least 7.62 cm (3 inches) on center from any neighboring hole. The sheet was then cleaned with MEK and scuffed with 180 Grit sandpaper (obtained from 3M Company) followed by a SCOTCH-BRITE scrubbing pad. 5.08 cm×17.78 cm (2 inch×7 inch) samples with ½″ punched out holes were applied to the aluminum sheet with 1.27 cm (0.5 inch) holes punched through to align with the holes drilled through the aluminum. The panel with sample applied was cured at 121.11° C. (250° F.) for one hour in a forced air oven. Upon removal, the panel was allowed to cool for four hour at which time 1.27 cm×5.08 cm (0.5 inch×2 inch) Grade 8 bolts equipped with a½ grade 8 washer were pushed through the hole such that the washer sandwiched the sample between the substrate. A nut was applied to the threaded end of each bolt and hand tightened. The bolts were torqued to 108.47 N·m (80 ft/lbs) via step torqueing (i.e., first to 25 ft/lbs, then 50 ft/lbs, and then 80 ft/lbs). The panel was then placed in a forced air oven at 65.56° C. (150° F.) for three days (72 hours). The panel was removed and allowed to cool over night before measuring the out torque.

### Electrical Resistance/Volume Resistivity Test

The methods of ASTM D257-14 were followed. Measurements were made for two samples (A and B) for each example.

### Bending Radius Test

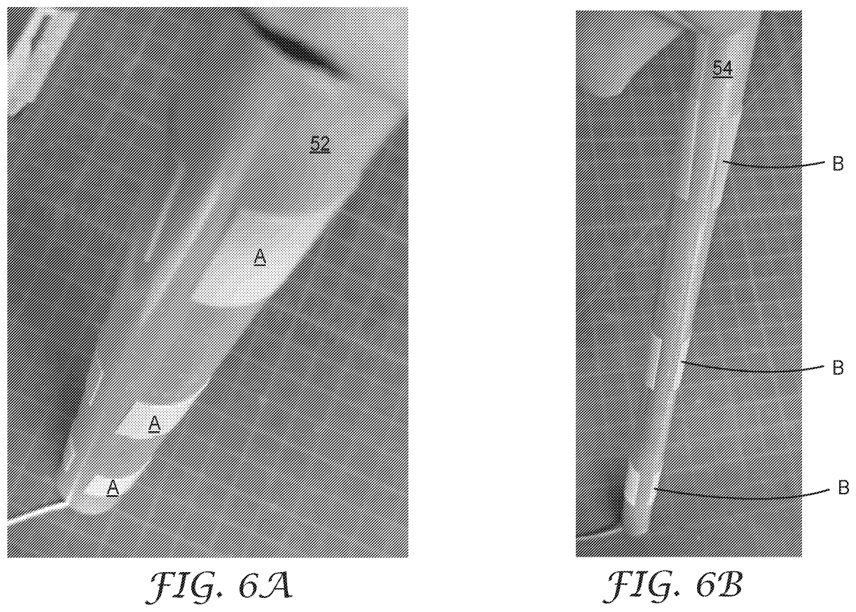

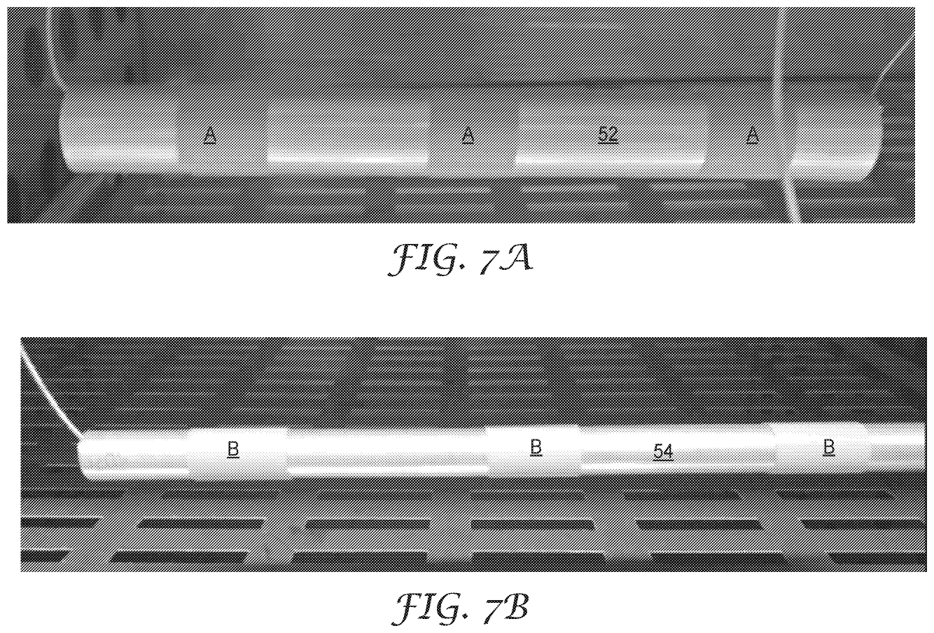

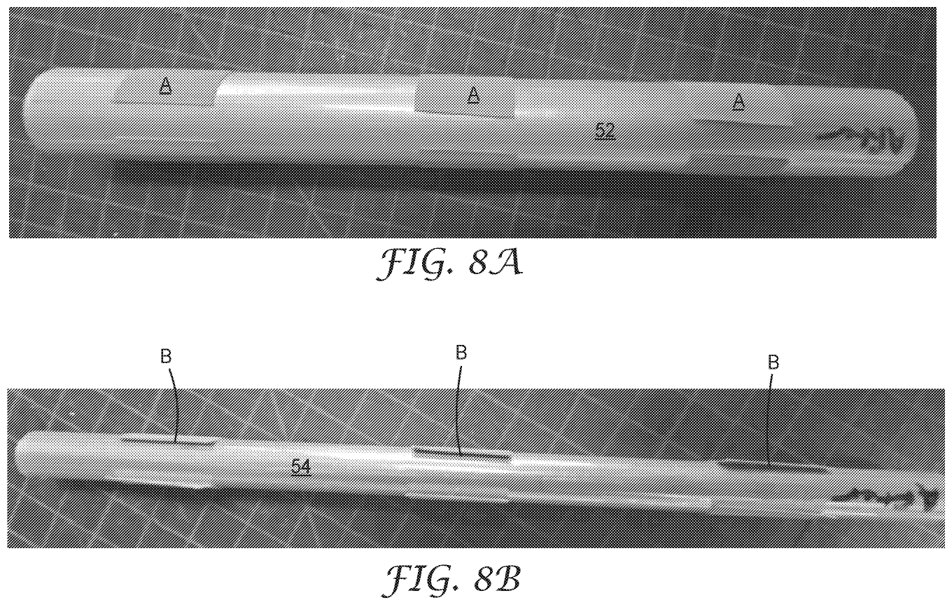

Referring to FIGS. 6A, 6B, 7A, 7B, 8A and 8B, two different size structural adhesive backed isolator samples were made using the Example 1 isolator material. Samples A were 1.0 inches (2.54 cm) wide and 2.75 inches (6.99 cm) long, and Samples B were 1.0 inches (2.54 cm) wide and 1.25 inches (3.18 cm) long. Two 10 inch (25.4 cm) long aluminum cylinders, one cylinder 52 having a 1.0 inch outside diameter and the other cylinder 54 having a 0.5 inch outside diameter were heated in an oven set at 110° F. for 20 minutes, and three samples of each size isolator were removed from frozen storage and heated in the same oven for one minute. The cylinders and samples were removed and the adhesive side of each of the three Samples A were applied lengthwise around the outer circumference of the 1.0 inch diameter cylinder (see FIG. 6A), and the adhesive side of each of the three Samples B were applied lengthwise around the outer circumference of the 0.5 inch diameter cylinder (see FIG. 6B). Afterwards, both cylinders, with the samples attached, were placed in an oven set at 250° F. until the adhesive layers were fully cured (see FIGS. 7A and 7B). After the adhesive layers were cured, all of the Samples A remained fully or substantially adhered to the 1″ dia. Cylinder (see FIG. 8A), but each of the Samples B exhibited lift off or pop off along the edge at each end of its length (see FIG. 8B). Such edge lift off of the Samples B could have been avoided by mechanically applying a pressure (e.g., with an elastic band, or clamp) at each end edge during the adhesive curing process.

### EXAMPLE 1 AND 2 (EX1 AND EX2)

A 0.254 mm (10 mil) thick layer of THY 500 was laminated to a 0.102 mm (4 mil) layer of SAT1.010. The fluoropolymer layer (THY 500) then received a plasma nanostructure treatment on its surface. The plasma nanostructure treatment was performed in a custom-built parallel plate capacitively coupled plasma reactor. After placing the film in the reactor on a central cylindrical powered electrode, with a surface area of 1.7 m ² (18.3 ft ²), the reactor chamber was pumped down to a base pressure of less than 1.3 Pa (2 mTorr). Oxygen and HMDSO were introduced into the chamber at flow rates of 750 SCCM and 45 SCCM, respectively. The treatment was carried out by coupling radio frequency (RF) power into the reactor at a frequency of 13.56 MHz and an applied power of 7500 watts, The treatment time was controlled by moving the film through the reaction zone at rate of 3.05 m/min. (10 ft min), resulting in an exposure time of 30 seconds. Following the treatment, RF power and the gas supply were terminated, and the chamber was returned to atmospheric pressure. Additional information regarding materials and processes for applying cylindrical plasma treatments and further details around the reactor used can be found in U.S. Pat. No. 8,460,568 (Moses et al), Which is incorporated by reference in its entirety. Torque, bending radius, and electrical resistance testing were conducted, and the results are represented in Table 2 and Table 3.

TABLE 2
Torque Loss Test Results

| | |
|---|---|
| DAY 1 | DAY 2 |

| | μ | σ | μ | σ |
|---|---|---|---|---|
| EX1 | 77.40 | 7.42 | 71.93 | 7.21 |
| EX2 | 70.97 | 0.74 | 70.63 | 2.21 |

TABLE 3
Volume Resistivity/Electrical Resistance Test Results

| | Volume Resistivity | | Electrical Resistance | |
|---|---|---|---|---|
| | (Ω · cm) | | (Ω) | |
| | Sample A | Sample B | Sample A | Sample B |
| Thickness (mm) | 0.386 | 0.395 | 0.386 | 0.395 |
| 10 v (60 s) | 7.0E+10 | 2.3E+11 | 1.0E+08 | 3.5E+08 |
| 100 v (60 s) | 8.7E+11 | 2.2E+12 | 1.3E+09 | 3.3E+09 |
| 1000 v (60 s) | 8.2E+12 | 2.3E+13 | 1.2E+10 | 3.4E+10 |

### Additional Embodiments

### Isolator Embodiments

1. An isolator for protecting adjacently located (e.g., mechanically fastened together) dissimilar material (e.g., metal containing) substrates from galvanic corrosion resulting from the difference in galvanic corrosion potential between the dissimilar materials, the isolator comprising:
an isolation or backing layer having opposite major surfaces, a thickness therebetween, and not being permanently compressible, at least under the conditions (e.g., the torque or applied pressure) of the mechanical fastening; and
an optional uncured adhesive layer having a thickness defined by opposite major surfaces, with one major surface being bonded to one of the major surfaces of the backing layer and another major surface being a major exposed surface adhesively bondable to a surface of one of the dissimilar substrates,
wherein the adhesive layer in its cured state is not permanently compressible, and at least one of the adhesive layer in its cured state and the backing layer is, and preferably both are, impermeable or at least resistant enough to polar solvents (e.g., water and ethylene glycol) and mixtures thereof so as to prevent the transfer of electrolytes (e.g., water transported metal ions) from passing all the way, mostly (more than halfway) or partially through its thickness. Polar solvents and mixtures thereof can act as corrosion agents by containing and allowing the transmission of ions or electrolytes therein. Optionally, at least one of the cured adhesive layer and the backing layer is, and preferably both are, electrically insulative, as measured according to ASTM D57-99.

As used herein, any reference to “dissimilar materials” refers to two or more materials (e.g., elemental, alloyed or metal containing composites) that exhibit a sufficient galvanic corrosion potential to warrant the use of an isolator to prevent one or both of the materials from galvanically corroding when in proximity to each other, especially in the presence of liquid water, water vapor, or other polar solvent(s). An example of such dissimilar materials is an aluminum containing material (e.g., an aluminum alloy) and an iron containing material (e.g., plain carbon or alloyed steel). Dissimilar material substrates useful with the present isolator can include., but are not limited to, uncoated or e-coated metals, such as aluminum and steel alloys, as well as carbon fiber polymer composites or any other composites containing metal components (e.g., metal fibers).

As used herein, mechanically fastened dissimilar material substrates are considered “protected” from galvanic corrosion by the isolator, when galvanic corrosion between the substrates is prevented or at least significantly minimized over the specified life (e.g., warranted life, operational life, or functional use) of the dissimilar material substrates. Galvanic corrosion between the substrates is considered significantly minimized, when the degree of galvanic corrosion present is not enough to prevent the safe operation or use of the dissimilar metal substrates.

It is desirable for the isolator, backing and cured adhesive layer to withstand being subjected to high elastic strain, without experiencing any, or any significant, plastic deformation (i.e., for the isolator to be used outside of its plastic deformation range). Therefore, as used herein, the term “not permanently compressible” or “not being permanently compressible”, as applied to the adhesive layer in its cured state, the backing layer, and/or the isolator, refers to a resistance to permanent (i.e., plastic or non-elastic) deformation that can produce a low torque loss in the range of from zero (i.e., no torque loss) up to and including at most about 15% and any range therebetween, when tested according to the “Torque Loss Test”. It is desirable for the isolator, backing layer and cured adhesive to each exhibit a torque loss in the range of from zero up to at most about 15%, and more desirably up to at most about 14%, 13%, 12%, 11%, 10%, 9%, 8%, 7%, 6% or 5%. The isolator is not permanently compressible, both when initially compressed and over the effective or intended life (i.e., creep resistant) of the dissimilar material substrate joint made with the isolator. In this way, the isolator can remain fixed in relation to its location between the dissimilar substrates so as not to allow movement of either substrate relative to the isolator, and in particular, such substrate movement that causes one or both of the substrates to wear away the isolator in its thickness direction, not only when the joint is initially formed but over the effective or intended life of the joint.

2. The isolator according to embodiment 1, wherein the isolator, when the adhesive layer is in its cured state, exhibits a torque loss in the range of from zero (i.e., no torque loss) up to and including at most about 15% and any range therebetween, as measured according to the “Torque Loss Test” and when the adhesive layer is in its cured state. It is desirable for the isolator to exhibit a torque loss in the range of from zero up to and including at most about 14%, 13%, 12%, 11%, 10%, 9%, 8%, 7%, 6% or 5%.
3. The isolator according to embodiment 1 or 2, wherein the backing layer exhibits a torque loss in the range of from zero up to at most about 15% and any range therebetween, as measured according to the Torque Loss Test. It is desirable for the backing layer to exhibit a torque loss in the range of from zero up to and including at most about 14%, 13%, 12%, 11%, 10%, 9%, 8%, 7%, 6% or 5%.
4. The isolator according to any one of embodiments 1 to 3, wherein the adhesive layer, in its cured state, exhibits a torque loss in the range of from zero up to at most about 15% and any range therebetween, as measured according to the Torque Loss Test. It is desirable for the cured adhesive layer to exhibit a torque loss in the range of from zero up to and including at most about 14%, 13%, 12%, 11%, 10%, 9%, 8%, 7%, 6% or 5%.
5. The isolator according to any one of embodiments 1 to 4, wherein the isolator is impermeable to polar solvents (e.g., water or ethylene glycol) and mixtures thereof or at least polar solvent resistant enough to prevent transported metal ions from passing all the way, mostly (more than halfway) or partially through its thickness.
6. The isolator according to any one of embodiments 1 to 5, wherein the adhesive layer in its cured state is polar solvent impermeable or at least polar solvent resistant enough to prevent polar solvent transported metal ions from passing all the way, mostly (more than halfway) or partially through its thickness.
7. The isolator according to any one of embodiments 1 to 6, wherein the backing layer is polar solvent impermeable or at least polar solvent resistant enough to prevent polar solvent transported metal ions from passing all the way, mostly (more than halfway) or partially through its thickness.
8. The isolator according to any one of embodiments 1 to 7, wherein the backing layer exhibits a heat distortion temperature (i.e., a temperature at which the backing layer can become permanently compressible) of greater than the temperature at which the adhesive layer cures.
9. The isolator according to any one of embodiments 1 to 8, wherein the adhesive layer is a thermosetting or thermoplastic structural adhesive. As used herein, a structural adhesive is not a pressure sensitive adhesive (PSA). In some applications, a PSA may be suitable such as, e.g., when the adhesive layer is only needed to keep the isolator in position on one of the dissimilar material substrates until the dissimilar material substrate joint is formed (e.g., until the substrates are mechanically fastened together and the isolator is compressed therebetween).
10. The isolator according to any one of embodiments 1 to 9, wherein the adhesive layer is selected from the group consisting of adhesives having a chemistry based on a benzoxazine, epoxy, phenolic, urethane, acrylic, BMI, phenyl-formaldehyde, or mixtures thereof
11. The isolator according to any one of embodiments 1 to 10, wherein the adhesive layer is selected from the group consisting of adhesives based on an epoxy chemistry.
12. The isolator according to any one of embodiments 1 to 11, wherein the backing layer is thermoformable into a three-dimensional shape.

The backing layer can be flat, or it can have a curved or complex three-dimensional configuration. The curved or complex three-dimension shape can be produced by heating to soften and deforming (e.g., via a DVT or other thermoforming technique) the backing layer to a shape that conforms to or matches the surface contours or topography of the dissimilar material substrate surface. The backing layer can be heated and deformed before it is bonded to the substrate surface. Alternatively, the backing layer can be bonded to the substrate surface at the same time it is being heated and deformed, with the heat being used to both soften the backing layer and cause curing of the adhesive layer.

13. The isolator according to any one of embodiments 1 to 12, wherein the isolator is thermoformable into a three-dimensional shape, when the adhesive layer is in an uncured state.
14. The isolator according to any one of embodiments 1 to 13, wherein the backing layer has a three-dimensional shape. Such a three-dimensional shape can include one or more two-dimensional or three-dimensional curved surfaces having a radius of curvature within the range of from about 2.5 mm up to about 25 mm).
15. The isolator according to any one of embodiments 1 to 14, wherein the adhesive layer, in its cured state, has a thickness in the range of from about 1 mil (25.4 microns) up to about 6 mil (152.4 microns), and preferably up to about 4 mil (101.6 microns).

It is desirable for the adhesive layer of the isolator to bond to an oily substrate surface having in the range of from 0 up to about 6.0 g/m² of oil, such as stamping oil (e.g., aliphatic stamping oils), on its surface, with the bond strength being characterized by overlap shear strength (OLS) values of greater than or equal to about 1000 psi (6.895 MPa).

It is desirable for the adhesive layer of the isolator to be curable by being exposed to a heating or other curing (e.g., actinic radiation) process that would otherwise be normally used in the process of manufacturing the assembly containing the isolator (e.g., one or more portions of an automobile, airplane or water craft). For example, in automobiles, it can be desirable for the adhesive layer to be cured when exposed to a typical automobile e-coat curing temperature (e.g., about 205° C.) and time cycle. It is desirable for such a normal curing cycle to at least initiate and progress the adhesive curing process to the point where the adhesive is cured to a bond strength (e.g., an OLS of greater than about 500 psi or 3.447 MPa) sufficient enough to survive subsequent or downstream processing of the assembly (e.g., an automobile).

16. The isolator according to any one of embodiments 1 to 15, wherein the backing layer has a thickness in the range of from about 1 mil (25.4 microns) up to about 20 mil (508 microns) or about 10 mil (254 microns). To ensure the backing layer exhibits adequate electrical resistivity while still being sufficiently bendable, and being polar solvent impermeable or at least polar solvent resistant enough to prevent polar solvent transported metal ions from passing all the way, mostly (more than halfway) or partially through its thickness, it may be desirable for the backing layer to have a thickness in the range of from about 10 mil (254 microns) up to about 20 mil (508 microns).
17. The isolator according to any one of embodiments 1 to 16, wherein it can be desirable for the backing layer to be made of a material having a Young's Modulus in the range of from about 0.20 GPa up to about 5.0 GPa, preferably in the range of from about 0.20 GPa up to about 3.0 GPa, and more preferably from about 1.5 GPa up to about 2.5 GPa, in order for the backing layer to not be permanently compressible (i.e., not plastically or non-elastically deformable), when compression forces are applied between the dissimilar material substrates (e.g., via a mechanical fastener). Preferably, the material chosen for making the backing layer is able to exhibits such a Young's Modulus at whatever temperatures the isolator will be exposed to during the manufacturing of the assembly (e.g., at temperatures of up to about 205° C.—to survive vehicle processing) or during its use.
18. The isolator according to any one of embodiments 1 to 17, wherein the backing layer consists of, consists essentially of or at least comprises a material selected from the group consisting of polyamide, PVDF, polysulfone, polyethersulfone, polyurethane, PEEK 4 GPa, PAEK, UHMW polyolefins, polyimides, polycarbonates, polyesters, polyacrylics, polyetherimide, PEK, THV.
19. The isolator according to any one of embodiments 1 to 18, wherein the backing layer exhibits a shear modulus in the range of from about 0.1 GPa up to about 30 GPa, and preferably in the range of from about 2.0 GPa up to about 10 GPa.
20. The isolator according to any one of embodiments 1 to 19, wherein, when necessary, the major surface of the backing layer, on which the adhesive layer is bonded and cured, can be surface treated to provide better adhesion between the adhesive layer and the backing layer. Such surface treatment can include, e.g., a flame treatment, corona treatment, flash-lamp treatment, IR lamp treatment, a primer coating, surface abrasion, and sand blasting).
21. The isolator according to any one of embodiments 1 to 20, wherein the isolator, when the adhesive layer is in its cured state, exhibits a degree of electrical resistance in the range of from about 1.0E+7Ω up to about 5.0E+10Ω, as measured according to the Electrical Resistance Test.

The present isolator can have the versatility to be used in automated, as well as manual, application processes. The present isolator is abrasion resistant and creep resistant enough to survive intact, not just when initially formed into the dissimilar material substrate joint, but also over the effective or intended life of the dissimilar material substrate joint. It is also desirable for the adhesive bond to be chemical resistant to most standard automotive fluids (ASTM 543-20). The present isolator can be adapted to be structurally bonded to a wide variety of substrate surface materials and topographies. For example, the present isolator can not only be readily bonded to flat substrate surfaces, but with the adhesive layer in its uncured state, the backing layer can be formed so as to be bondable to simple-curved, complex-curved or other non-flat surface configurations and application, such as but not limited to being edge wrapped (e.g., see FIG. 5). The present isolator can have any desired surface area needed to adequately protect the dissimilar material substrates from galvanic corrosion.

When it includes an adhesive layer, the present isolator can be optimized so that the adhesive layer cures while being processed in an existing automotive process (e.g., the bake cycles used in liquid paint drying and e-coat curing processes). Once the adhesive layer is cured, it is also desirable for the materials used for the isolator (both backing and adhesive layers) to be chosen so that the isolator can survive such automotive e-coat curing and liquid paint drying processes. In addition, with a layer of adhesive on only one side, the present isolator allows for the joint of dissimilar material substrates to be readily disassembled after the adhesive layer is cured, which facilitates the serviceability of the apparatus (e.g., an automobile, aircraft, or watercraft) containing the dissimilar material joint. For example, if an aluminum truck bed is isolated from its steel frame, using the present invention, and the truck bed needs to be replaced or repaired due, e.g., to an accident, the present invention would facilitate such replacement or repair.

It is desirable for the adhesive chosen for the adhesive layer to have at least a six-month shelf life of use, after being manufactured, at room temperature and an indefinite (i.e., almost forever) shelf life when kept in a frozen state. It is also desirable for the adhesive layer to be bondable to substrates having surfaces contaminated with standard stamping, drawing or other processing oils and other lubricants, in order to minimize the need for preparatory cleaning operations. It is desirable for the strength of the bond between the adhesive layer and the corresponding dissimilar material substrate to exhibit a service temperature in the range of from about −40° F. to 180° F.

Potential Applications for the present isolator include, but are not limited to, any automotive, aerospace and commercial vehicle application(s) requiring the isolation of dissimilar material substrates, such as the bumper, truck bed, body, trailer, bed to frame, or e-powertrain applications. The present isolator can also be used in electronic applications requiring such isolation.

It is desirable for the isolator, or at least the backing layer, to exhibit the above properties over the range of temperatures a vehicle is used or assembled (e.g., from about −55° C. up to about 205° C.).

### Isolated Substrate Joint Embodiments

22. An isolated substrate joint comprising:
two dissimilar material substrates;
at least one isolator according to any one of embodiments 1 to 21, with the isolator being disposed between the two dissimilar material substrates; and
a mechanical fastener connecting together the dissimilar material substrates, with the at least one isolator therebetween, so the at least one isolator remains fixed in relation to its location between the dissimilar substrates so as not to allow movement of either dissimilar material substrate, relative to the isolator, that causes wearing away of the isolator in its thickness direction.
   23. The isolated substrate joint of embodiment 22, wherein the mechanical fastener is at least one mating nut and bolt, with the treaded portion of each bolt being located within and passing through a hole formed through one the isolator and each dissimilar material substrate, and a corresponding nut being tightened onto each bolt to a torque in the range from at least about 30 Nm (22.1 Ft./lbs.) up to at least about 110 Nm (81.1 Ft./lbs.) and any amount therebetween. For example, it may be desirable to tighten the nut to a torque of at least about 105 Nm (77.4 Ft./lbs.)100 Nm (73.76 Ft./lbs.), 90 Nm (66.4 Ft./lbs.), 80 Nm (59 Ft./lbs.), 70 Nm (51.6 Ft./lbs.), Nm (44.3 Ft./lbs.), 50 Nm (36.9 Ft./lbs.), 40 Nm (29.5 Ft./lbs.), or 30 Nm (22.1 Ft./lbs.).
   24. The isolated substrate joint of embodiment 22 or 23, wherein each dissimilar material substrate has a three-dimensional surface profile or shape, and the isolator has a three-dimensional profile or shape, such that when the isolator is disposed between the dissimilar material substrates and the dissimilar material substrates are mechanically secured together, the corresponding three-dimensional surface profiles or shapes mate together so as to mechanically interlock the isolator between the dissimilar material substrates.

### Method of Protecting Dissimilar Material Substrates Embodiments

25. A method of protecting mechanically fastened dissimilar material substrates from galvanic corrosion, the method comprising:
providing a first substrate comprising a first material and a second substrate comprising a second material, where the first material and the second material are dissimilar materials (e.g., steel and aluminum);
providing an isolator according to any one of embodiments 1 to 21;
optionally bonding the isolator with an adhesive to a surface of the first substrate;
disposing the isolator between the first substrate and the second substrate; and
mechanically securing together the first and second substrates such that the isolator is disposed therebetween in an elastically compressed state.
   26. The method according to embodiment 25, further comprising:
providing a mechanical fastener (e.g., a nut and bolt) for mechanically securing together the first and second material substrates,
wherein the first and second substrates are mechanically secured using the mechanical fastener.
   27. The method according to embodiment 25 or 26, wherein each of the first and second substrates are provided with a through-hole, the mechanical fastener comprises at least one or a plurality of matching nuts and bolts, and the mechanically securing together further comprises:
disposing each bolt through one through-hole of each of the first and second substrates;
threading a matching nut on a threaded end of each bolt; and
torqueing each matching nut until the isolator is in a compressed state.
   28. The method according to any one of embodiments 25 to 27, further comprising:
adhesively bonding the isolator to a surface of the first substrate,
wherein the adhesively bonding the isolator further comprises curing the adhesive layer, before the first and second substrates are mechanically secured together.
   29. The method according to any one of embodiments 25 to 28, further comprising:
adhesively bonding the isolator to a surface of the first substrate;
wherein the adhesively bonding the isolator further comprises curing the adhesive layer, after the first and second substrates are mechanically secured together.
   30. The method according to claim 29, further comprising:
providing a mechanical fastener for mechanically securing together the first and second substrates,
wherein said mechanical fastener is at least one mating nut and bolt, with each bolt being located within a hole formed through one isolator and each dissimilar material substrate, and said mechanically securing together the first and second substrates comprises tightening a corresponding nut onto each bolt to a torque in the range from at least about 30 Nm (22.1 Ft./lbs.) up to at least about 110 Nm (81.1 Ft./lbs.).
   31. The method according to any one of embodiments 25 to 30, further comprising:
applying a corrosion-resistant layer (e.g., an automotive e-coat) onto the surface of the first substrate, before the adhesively bonding the isolator.
   32. The method according to any one of embodiments 25 to 31, further comprising:
applying a corrosion-resistant layer (e.g., an automotive e-coat) onto a surface of the second substrate, before or after the adhesively bonding the isolator.
   33. The method according to any one of embodiments 25 to 32, wherein the first substrate has a three-dimensional surface profile or shape, the second substrate has a three-dimensional surface profile or shape, and the isolator has a three-dimensional profile or shape, such that when the isolator is disposed between the first and second substrates and the first and second substrates mechanically secured together, the corresponding three-dimensional surface profiles or shapes mate together so as to mechanically interlock the isolator between the first and second substrates.

This invention may take on various modifications and alterations without departing from its spirit and scope. Accordingly, this invention is not limited to the above-described but is to be controlled by the limitations set forth in the following claims and any equivalents thereof This invention may be suitably practiced in the absence of any element not specifically disclosed herein. All patents and patent applications cited above, including if in the Background section, are incorporated by reference into this document in total.

1. An isolator for protecting adjacently located dissimilar material substrates from galvanic corrosion, said isolator comprising:
a backing layer having opposite major surfaces, a thickness therebetween, and not being permanently compressible; and
an optional uncured adhesive layer having a thickness defined by opposite major surfaces, with one major surface being bonded to one of the major surfaces of the backing layer and another major surface being a major exposed surface adhesively bondable to a surface of one of the dissimilar substrates,
wherein the adhesive layer in its cured state is not permanently compressible, and at least one of the adhesive layer in its cured state and the backing layer is polar solvent resistant enough to prevent polar solvent transported metal ions from passing all the way through its thickness.

2. The isolator according to claim 1, wherein the isolator includes the adhesive layer in its cured state and exhibits a torque loss in the range of from zero up to and including at most about 15%, as measured according to the “Torque Loss Test”.

3. The isolator according to claim 1, wherein said isolator is polar solvent resistant enough to prevent polar solvent transported metal ions from passing all the way through its thickness.

4. The isolator according to claim 1, wherein the isolator includes the adhesive layer, and the backing layer exhibits a heat distortion temperature of greater than the temperature at which the adhesive layer cures.

5. The isolator according to claim 1, wherein the isolator includes the adhesive layer, and the isolator is thermoformable into a three-dimensional shape, when the adhesive layer is in an uncured state.

6. The isolator according to claim 1, wherein the isolator includes the adhesive layer, and the adhesive layer in its cured state has a thickness in the range of from about 1 mil (25.4 microns) up to about 6 mil (152.4 microns), and the backing layer has a thickness in the range of from about 1 mil (25.4 microns) up to about 20 mil (508 microns)

7. The isolator according to claim 1, wherein the backing layer is made of a material having a Young's Modulus in the range of from about 0.20 GPa up to about 5.0 GPa.

8. The isolator according to claim 1, wherein the backing layer comprises a tetrafluoroethylene, hexafluoropropylene and vinylidene fluoride (THV) material.

9. The isolator according to claim 1, wherein the backing layer exhibits a shear modulus in the range of from about 0.1 GPa up to about 30 GPa.

10. An isolated substrate joint comprising:
two dissimilar material substrates;
at least one isolator according to claim 1, with said isolator being disposed between said two dissimilar material substrates; and
a mechanical fastener connecting together said dissimilar material substrates, with said at least one isolator therebetween, so said at least one isolator remains fixed in relation to its location between the dissimilar substrates so as not to allow movement of either dissimilar material substrate, relative to said isolator, that causes wearing away of said isolator in its thickness direction.

11. The isolated substrate joint of claim 10, wherein each dissimilar material substrate has a three-dimensional surface profile or shape, and the isolator has a three-dimensional profile or shape, such that when the isolator is disposed between the dissimilar material substrates and the dissimilar material substrates are mechanically secured together, the corresponding three-dimensional surface profiles or shapes mate together so as to mechanically interlock the isolator between the dissimilar material substrates.

12. A method of protecting mechanically fastened dissimilar material substrates from galvanic corrosion, said method comprising:
providing a first substrate comprising a first material and a second substrate comprising a second material, where the first material and the second material are dissimilar materials;
providing an isolator according to claim 1;
optionally bonding the isolator with an adhesive to a surface of the first substrate;
disposing the isolator between the first substrate and the second substrate; and
mechanically securing together the first and second substrates such that the isolator is disposed therebetween in a compressed state.

13. The method according to claim 12, further comprising:
providing a mechanical fastener for mechanically securing together the first and second substrates,
wherein the first and second substrates are mechanically secured using the mechanical fastener such that the isolator is in a compressed state.

14. The method according to claim 12, further comprising:
adhesively bonding the isolator to a surface of the first substrate,
wherein said adhesively bonding the isolator further comprises curing the adhesive layer, after the first and second substrates are mechanically secured together.

15. The method according to claim 14, further comprising:
providing a mechanical fastener for mechanically securing together the first and second substrates,
wherein said mechanical fastener is at least one mating nut and bolt, with each bolt being located within a hole formed through one isolator and each dissimilar material substrate, and a corresponding nut being tightened onto each bolt to a torque in the range from at least about 30 Nm (22.1 Ft./lbs.) up to at least about 110 Nm (81.1 Ft./lbs.).
